(19) United States
(12) Patent Application Publication
(10) Pub. No.: US 2014/0351483 A1
(43) Pub. Date: Nov. 27, 2014

(54) MOTHERBOARD WITH PERIPHERAL COMPONENT INTERCONNECT EXPRESS SLOTS

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: WU ZHOU, Shenzhen (CN); MENG-LIANG YANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/288,355

(22) Filed: May 27, 2014

(30) Foreign Application Priority Data
May 27, 2013 (CN) 2013101996388

(51) Int. Cl. G06F 13/28; G06F 13/42

(52) U.S. Cl. CPC G06F 13/287; G06F 13/4221
USPC 710/313

(57) ABSTRACT

A motherboard (100) includes an X16-lane PCIE slot (1), an X8-lane PCIE slot (2), a controller (3), and a multiplexer (7). A feedback pin of the X16-lane PCIE slot (1) outputs a feedback signal when an X16-lane PCIE card is inserted into the X16-lane PCIE slot (1). When the multiplexer (7) does not receive the feedback signal, two X8-lane PCIE cards can be inserted into the X16-lane PCIE slot (1) and the X8-lane PCIE slot (2), respectively, to communicate with the controller (3). When an X16-lane PCIE card is inserted into the X16-lane PCIE slot (1), the multiplexer (7) receives the feedback signal, and the X16-lane PCIE card can communicate with the controller (3) through the X16-lane PCIE slot (1).

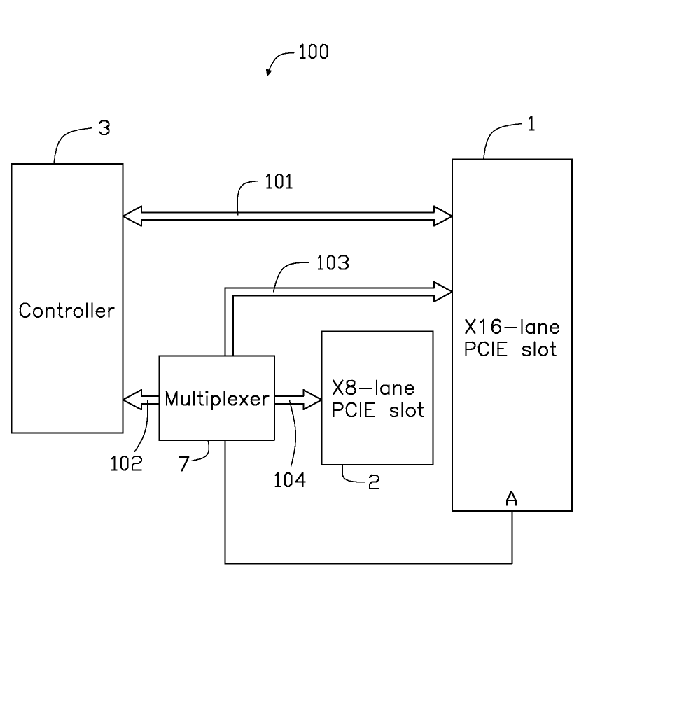

### FIELD

The subject matter herein generally relates to a motherboard with Peripheral Component Interconnect Express (PCIE) slots.

### BACKGROUND

At present, many different kinds of PCIE slots are arranged on a motherboard. A multi-lane slot, such as an X16-lane slot, needs a high specification of arrangement of traces on the motherboard, such as add a layer.

### BRIEF DESCRIPTION OF THE DRAWING

Implementations of the present technology will now be described, by way of example only, with reference to the attached figure, wherein:

The figure is a schematic diagram of an embodiment of a motherboard.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

The present disclosure is described in relation to a motherboard with an X16-lane PCIE slot and an X8-lane PCIE slot that an X16-lane PCIE card can transmit data to the X16-lane PCIE slot without complicated wires.

The figure illustrates an embodiment of a motherboard 100. An X16-lane PCIE slot 1, an X8-lane PCIE slot 2, a controller 3, and a multiplexer 7 are arranged on the motherboard 100.

The PCIE slots can transmit data to corresponding PCIE cards, the corresponding PCIE cards having channels equivalent to or less than the channels of the PCIE slots. For example, the X16-lane PCIE slot 1 can transmit data to an X16-lane PCIE card (not shown)or an X8-lane PCIE card (not shown), and the X8-lane PCIE slot 2 can transmit data to an X8-lane PCIE card (not shown) at most.

The controller 3 is coupled to the X16-lane PCIE slot 1 by first eight pairs of channels 101, and further coupled to the multiplexer 7 by second eight pairs of channels 102. The multiplexer 7 is coupled to the X16-lane PCIE slot 1 by third eight pairs of channels 103, and further coupled to the X8-lane PCIE slot 2 by fourth eight pairs of channels 104. A feedback pin A of the X16-lane PCIE slot 1 is coupled to the multiplexer 7.

When X8-lane PCIE cards are inserted into both the X16-lane PCIE slot 1 and the X8-lane PCIE slot 2, the multiplexer 7 does not receive a feedback signal from the feedback pin A of the X16-lane PCIE slot 1, so the multiplexer 7 connects the second eight pairs of channels 102 to the fourth eight pairs of channels 104, and disconnects the second eight pairs of channels 102 from the third eight pairs of channels 103. Thus, the controller 3 can communicate with the X8-lane PCIE card in the X16-lane PCIE slot 1 through the first eight pairs of channels 101, and communicate with the X8-lane PCIE card in the X8-lane PCIE slot 2 through the second eight pairs of channels 102 and the fourth eight pairs of channels 104.

When an X16-lane PCIE card is inserted in the X16-lane PCIE slot 1, the multiplexer 7 receives a feedback signal from the feedback pin A of the X16-lane PCIE slot 1, so the multiplexer 7 connects the second eight pairs of channels 102 to the third eight pairs of channels 103, and disconnects the second eight pairs of channels 102 from the fourth eight pairs of channels 104. Thus, the controller 3 can communicate with the X16-lane PCIE card in the X16-lane PCIE slot 1 through the first eight pairs of channels 101 and the second eight pairs of channels 102 and the third eight pairs of channels 103.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A motherboard (100), comprising:
a controller (3);
an X16-lane Peripheral Component Interconnect Express (PCIE) slot (1) coupled to the controller (3) by a first eight pairs of channels (101);
a multiplexer (7) coupled to the controller (3) by second a eight pairs of channels (102) and coupled to the X16-lane PCIE slot (1) by a third eight pairs of channels (103); and
a X8-lane PCIE slot (2) coupled to the multiplexer (7) by a fourth eight pairs of channels (104);
wherein the multiplexer (7) is also coupled to a feedback pin of the X16-lane PCIE slot (1);
wherein when the multiplexer (7) has not received a feedback signal from the feedback pin of the X16-lane PCIE slot (1), the multiplexer (7) connects the second eight pairs of channels (102) to the fourth eight pairs of channels (104);
wherein when the multiplexer (7) receives a feedback signal from the feedback pin of the X16-lane PCIE slot (1), the multiplexer (7) connects the second eight pairs of channels (102) to the third eight pairs of channels (103); and
wherein the feedback pin of the X16-lane PCIE slot (7) outputs the feedback signal when an X16-lane PCIE card is inserted in the X16-lane PCIE slot (1).
